(19) United States
(12) Patent Application Publication
(10) Pub. No.: US 2025/0386335 A1
(43) Pub. Date: Dec. 18, 2025

(54) ULTRA-WIDEBAND RETRANSMISSIONS WITH CHANNEL HOPPING

(71) Applicant: QUALCOMM Incorporated, San Diego, CA (US)

(72) Inventors: Varun Amar REDDY, San Diego, CA (US); Aleksandar DAMNJANOVIC, Del Mar, CA (US); Krishna Kiran MUKKAVILLI, San Diego, CA (US)

(21) Appl. No.: 18/742,523

(22) Filed: Jun. 13, 2024

(51) Int. Cl. H04W 72/12; H04B 1/713

(52) U.S. Cl. CPC H04W 72/12; H04B 1/713

(57) ABSTRACT

A device for avoiding interference. The device comprising: at least one transceiver; at least one memory; and at least one processor, in signal communication with the at least one transceiver, and the at least one memory, the at least one processor configured to: transmit, with the at least one transceiver, a ranging control message (RCM) to schedule a ranging session with a second device, where the ranging session includes a plurality of consecutive ranging blocks, each ranging block includes a plurality of ranging rounds, each ranging round includes a plurality of ranging slots, and the schedule includes a channel hopping pattern for the plurality of ranging slots; transmit a ranging initiation message (RIM) on a first ranging slot; and retransmit the RIM on a second ranging slot, different from the first ranging slot, baes on the channel hopping pattern.

### BACKGROUND

Ultra-wideband (UWB) is a wireless technology that utilizes wideband radio waves and can use very low energy levels for short-range, high-bandwidth communications over a large portion of the radio spectrum. UWB signal energy may be transmitted without interfering with narrowband and carrier wave transmission in the same frequency band. Compared to Wi-Fi or BLUETOOTH® communications, UWB operates in higher frequency bands and uses a wider bandwidth (i.e., 500 megahertz or more). These special characteristics of UWB allow it to measure distance and determine position much more accurately than other technologies, providing the basis for building more secure applications. In general, UWB has applications in non-cooperative radar imaging, target sensor data collection, precise locating, tracking, and digital car keys. At present, the UWB spectrum is presently divided into channels 1-15 spanning frequencies from about 3.5 GHz to about 4.5 GHz and from about 6.5 GHz to about 10 GHz.

In addition to UWB communication systems, future cellular communication systems, such as, for example, future 5G and 6G systems, are also planning on utilizing a frequency spectrum that includes about 7 GHz to 24 GHz. As such, there may issues of interference between the UWB spectrum and the planned future cellular frequency spectrum as both types of systems coexist within the 7 GHz to 10 GHz frequency band.

### SUMMARY

Techniques are discussed for devices with channel hopping, e.g., for avoiding interference. An example device comprises: at least one transceiver; at least one memory; and at least one processor, in signal communication with the at least one transceiver, and the at least one memory, the at least one processor configured to: transmit, with the at least one transceiver, a ranging control message (RCM) to schedule a ranging session with a second device, where the ranging session includes a plurality of consecutive ranging blocks, each ranging block includes a plurality of ranging rounds, each ranging round includes a plurality of ranging slots, and the schedule includes a channel hopping pattern for the plurality of ranging slots; transmit a ranging initiation message (RIM) on a first ranging slot; and retransmit the RIM on a second ranging slot, different from the first ranging slot, based on the channel hopping pattern. In this example, the device may be a ranging device.

Also discussed are methods for channel hopping with devices. An example method may include transmitting, with an at least one transceiver, a RCM to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; transmitting a RIM on a first ranging slot; and retransmitting the RIM on a second ranging slot, different from the first ranging slot, based on the channel hopping pattern.

Another example device comprises: means for transmitting a RCM to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; means for transmitting a RIM on a first ranging slot; and means for retransmitting the RIM on a second ranging slot, different from the first ranging slot, based on the channel hopping pattern.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

FIG. 1 is a functional system block diagram of an example of an implementation of a first ranging device and a second ranging device configured to communicate with each other over an Ultra-wideband (UWB) spectrum in accordance with the present disclosure.

FIG. 2 is a functional system block diagram of an example of an implementation of a ranging device and a plurality of ranging devices acting as anchors conformally located around an automobile in accordance with the present disclosure.

FIG. 3 is a functional system block diagram of an example of an implementation of a frequency operated button (FOB) and a plurality of anchors conformally located around an automobile in accordance with the present disclosure.

FIG. 4 is a frequency plot of a UWB frequency band and a future 5G New Radio (NR) frequency band.

FIG. 5A is an example of a message flow diagram illustrating roles that different ranging devices may assume within a UWB ranging session.

FIG. 5B is another example of a message flow diagram illustrating roles that the different ranging devices may assume within the UWB ranging session.

FIG. 6 is a signal time diagram illustrating how time may be segmented and utilized within a UWB positioning session.

FIG. 7 is a signal flow diagram of communications between a first ranging device and a second ranging device in accordance with the present disclosure.

FIG. 8 is a functional system block diagram illustrating an example of a cluster of anchors in accordance with the present disclosure.

FIG. 9 is a signal time diagram illustrating how a first message is transmitted and a second message is received within a ranging slot of the slots shown in FIG. 6.

FIG. 10 is a functional block diagram of an example of communication between the first ranging device and the second ranging device in accordance with the present disclosure.

FIG. 11 is a functional block diagram of an example of communication between the first ranging device and the second ranging device utilizing slot-by-slot channel hopping within the same round in accordance with the present disclosure.

FIG. 12 is a functional block diagram of another example of communication between the first ranging device and the second ranging device utilizing slot-by-slot channel hopping within the same round in accordance with the present disclosure.

FIG. 13 is a flowchart of an example of an implementation of a method for avoiding interference with a device in accordance with the present disclosure.

FIG. 14 is a flowchart of another example of an implementation of a method for avoiding interference with a UWB device in accordance with the present disclosure.

### DETAILED DESCRIPTION

Techniques are discussed for devices with channel hopping, e.g., for avoiding interference. An example device comprises: at least one transceiver; at least one memory; and at least one processor, in signal communication with the at least one transceiver, and the at least one memory, the at least one processor configured to: transmit, with the at least one transceiver, a ranging control message (RCM) to schedule a ranging session with a second device, where the ranging session includes a plurality of consecutive ranging blocks, each ranging block includes a plurality of ranging rounds, each ranging round includes a plurality of ranging slots, and the schedule includes a channel hopping pattern for the plurality of ranging slots; transmit a ranging initiation message (RIM) on a first ranging slot; and retransmit the RIM on a second ranging slot, different from the first ranging slot, utilizing the channel hopping pattern. In this example, the device may be a ranging device such as an Ultra-wideband (UWB) device.

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for UWB, IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “positioning reference signals,” “reference signals for positioning,” and the like may be used to refer to signals used for positioning of a mobile device, such as a UWB device. As described in more detail herein, such signals may comprise any of a variety of signal types. Additionally, unless otherwise specified, references to “sensing reference signals,” “reference signals for sensing,” and the like may be used to refer to signals used for RF sensing (also generically referred to herein as “sensing”) as described herein. A signal used for RF sensing and/or positioning may be generally referred to herein as a reference signal (RS). As described in more detail herein, such signals may comprise any of a variety of signal types but may not necessarily be limited to signals solely used for RF sensing.

Further, unless otherwise specified, the term “positioning,” “position determination,” “location determination,” “location estimation,” and the like, as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

UWB-based positioning offers a highly accurate, low-power positioning solution relative to other RF-based positioning techniques for wireless electronic devices. UWB is a wireless technology that utilizes wideband radio waves and can use very low energy levels for short-range, high-bandwidth (500 megahertz or more) communications over a large portion of the radio spectrum. In general, UWB allows for distance measurements and position determinations that are more accurate than other technologies, which provides the basis for building more secure applications. UWB has applications in non-cooperative radar imaging, robots and/or IoT devices in a factory setting, indoor positioning of consumer electronics, target sensor data collection, precise locating, tracking, automobile digital keys, and more.

UWB-based positioning may be facilitated by groups or “clusters” of UWB devices known as “anchors” that each have a fixed relative position that can be utilized for positioning. For certain types of positioning, such as time difference of arrival (TDOA), the respective clocks of these anchors may be synchronized to provide for precise transmission of signals, relative to each other. Time synchronization of a network of overlapping clusters may be provided by a Global anchor.

In general, while UWB signal energy may be transmitted without interfering with narrowband and carrier wave transmission in the same frequency band, a potential issue exists between UWB communications and future cellular communication systems (such as, for example, future 5G and 6G systems) that are planning on utilizing a frequency spectrum that overlaps part of the UWB spectrum. Specifically, the UWB spectrum utilizes frequencies from about 3.5 GHz to about 4.5 GHz and from about 6.5 GHz to about 10 GHz. However, future cellular communication systems are also planning on utilizing a frequency spectrum that includes about 7 GHz to 24 GHz. As such, there may be issues of interference between the UWB devices and the future cellular devices because both types of systems will coexist within the 7 GHz to 10 GHz frequency band.

In examples discussed, the UWB devices may use pulse-based radio signaling (e.g. Short-pulse-UWB) instead of OFDM-based signaling (Multi-Band OFDM UWB). Short-pulse-UWB signaling transmits with the energy for each bit spread over the entire UWB channel bandwidth (e.g., 1.37 GHz, 4 GHz, etc.) with varying pulse amplitude and/or pulse polarity without using a RF carrier while MB-OFDM (Multi-Band-OFDM) transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g. Gaussian pulses, Monocycle pulses, Hermite pulses, etc) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high speed Analog-to-Digital converter (ADC) and a high speed Digital-to-Analog Converter (DAC) to be able to handle the very wide frequency band used; however, there may be other ways to handle the need for ultra-fast sampling such as using Time Hopping techniques, Direct Sequence coding techniques, etc.

Multiband OFDM UWB divides up spectrum into several frequency sub-bands and OFDM is applied within each band; whereas, other OFDM systems typically operate within a fixed frequency band. The complex waveform created by combining the multiple-sub-bands results in a final waveform that used for transmission for Multiband OFDM UWB. Multiband OFDM UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

As such, it is desired to mitigate the interference from these future cellular communication systems on UWB communications. Specifically, 6G interference may affect UWB performance, because if one or more UWB slots are affected, it prevents the UWB device from achieving a Double-sided Two-Way Ranging (DS-TWR) with a responder. In one embodiment, a UWB device may have a deterministic or random/pseudo-random channel hopping pattern for UWB that is provided in the session configuration to another UWB device. This can be based on a packet-specific confidence (PSC) metric, which enables a slot-by-slot hopping mechanism. In another embodiment, the channel hopping pattern may be based on channel-specific confidence (CSC) metric, which is maintained over a duration of a ranging round.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

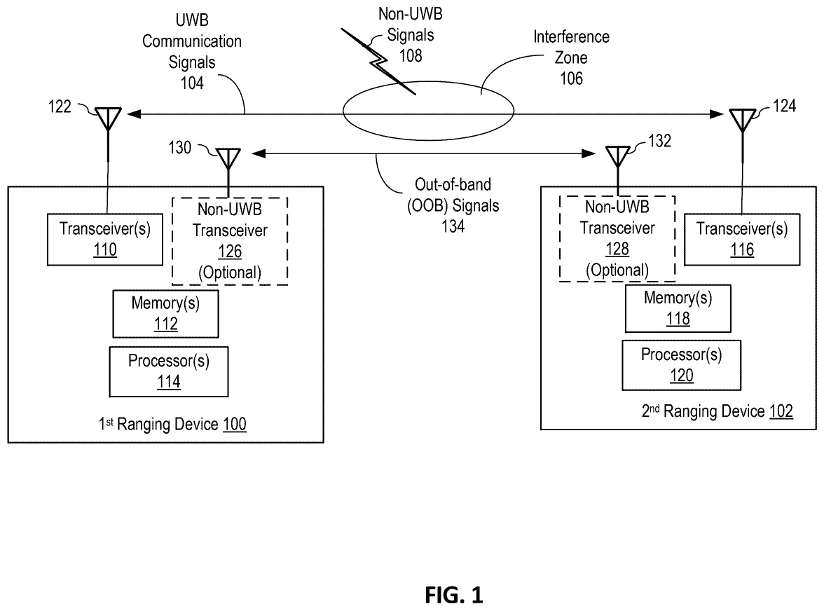

Turning to FIG. 1, a system block diagram is shown of an example of an implementation of a first device (i.e., ranging device 100 that may be, for example, a UWB device) and a second ranging device 102 configured to communicate with each other over the UWB spectrum. The first ranging device 100 and second ranging device 102 may be each UWB devices. In this example, the first ranging device 100 and second ranging device 102 are configured to perform transmissions and retransmissions of communication signals 104 between the UWB devices (i.e., the first RANGING DEVICE 100 and second ranging device 102) with slot-to-slot channel hopping which may help avoid potential signal interference in an interference zone 106 caused by non-UWB signals 108 transmitting within the interference zone 106. The non-UWB signals 108 may be, for example, future 5G and 6G signals (i.e., transmission standards proposed by the International Mobile Telecommunications (IMT) of the International Telecommunication Union (ITU)) operating within the about 7 GHz to 10 GHz frequency spectrum.

In general, the first ranging device 100 may include at least one transceiver 110, at least one memory 112, and at least one processor 114 in signal communication with the at least one transceiver 110, and the at least one memory 112. Similarly, the second ranging device 102 may include at least one transceiver 116, at least one memory 118, and at least one processor 120 in signal communication with the at least one transceiver 116, and the at least one memory 118. In this example, the first ranging device 100 may also include at least one antenna 122 and the second ranging device 102 may include at least one antenna 124 to transmit and receive the UWB communication signals 104. The first ranging device 100 and second ranging device 102 may each also optionally include a non-UWB transceiver (i.e., non-UWB transceiver 126 for the first ranging device 100 and non-UWB transceiver 128 for the second ranging device 102) in signal communication with an optional non-UWB antenna (i.e., non-UWB antenna 130 for the first ranging device 100 and non-UWB antenna 132 for the second ranging device 102). In this example, the optional non-UWB transceiver 126 and non-UWB transceiver 128 may communicate via out-of-band (OOB) signals 134 between the non-UWB antenna 130 and non-UWB antenna 132 of the first ranging device 100 and second ranging device 102, respectively. As an example, the OOB signals may be any narrow band type signals such as, for example, BLUETOOTH® or Wi-Fi® signals.

In this example, the optional non-UWB transceiver 126 and non-UWB antenna 130 may be part of, or optionally separate devices from, the at least one transceiver 110 and at least one antenna 122. Similarly, the optional non-UWB transceiver 128 and non-UWB antenna 132 may be part of, or optionally separate devices from, the at least one transceiver 116 and at least one antenna 124. In this example, the non-UWB transceiver 126, non-UWB antenna 130, non-UWB transceiver 128, and non-UWB antenna 132 may also optionally be part of the at least one transceiver 110, at least one antenna 122, at least one transceiver 116, and at least one antenna 124, respectively.

In an example of operation, the at least one processor 114 of the first ranging device 100 may transmit to the second ranging device 102 an RCM (i.e., a ranging control message) to schedule a UWB ranging session (generally referred to as a “ranging session”) between the first ranging device 100 and the second ranging device 102. The RCM may be transmitted either by the at least one transceiver 110, via the UWB communications signals 104, or by the optional non-UWB transceiver 126 via the OOB signals 134.

As an example, the UWB ranging session may include a plurality of consecutive ranging blocks, where each ranging block includes a plurality of ranging rounds, and each ranging round includes a plurality of ranging slots. The schedule may include a channel hopping pattern for the plurality of ranging slots. The at least one processor 114 may also be configured to transmit a ranging initiation message (RIM) on a first ranging slot and retransmit the RIM on a second ranging slot, different from the first ranging slot, utilizing the channel hopping pattern.

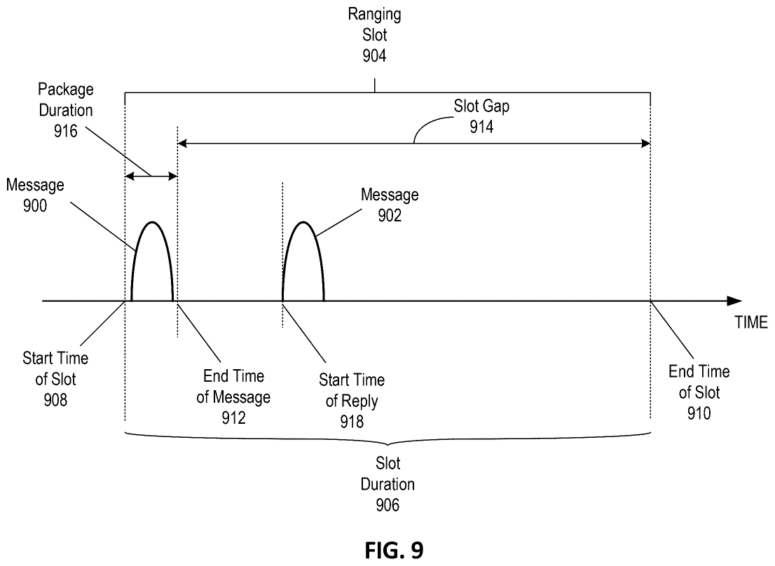

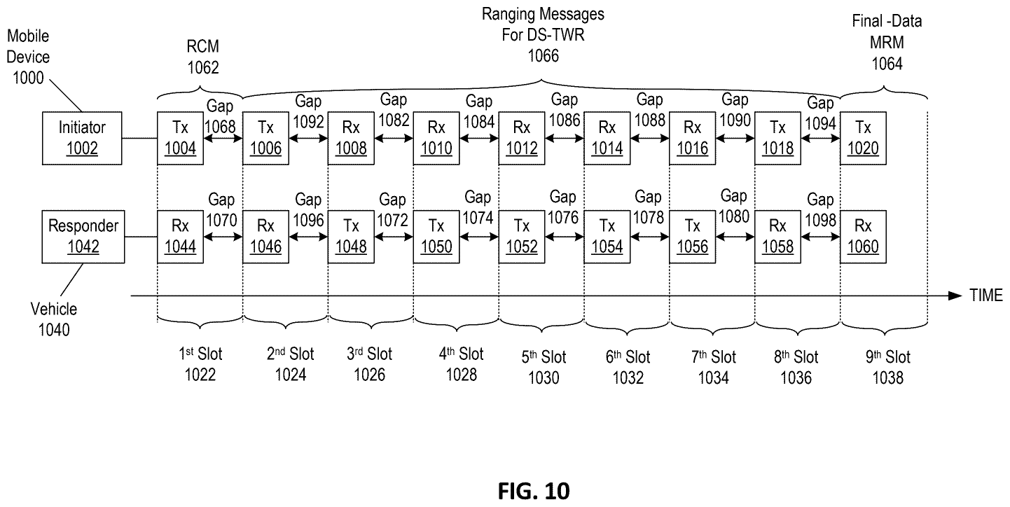

In this example, as will be discussed later in relation to FIGS. 9 and 10, each ranging slot may have a slot duration that is equal to between approximately 1 millisecond (ms) and approximately 2.66 ms, and the RIM may include a data packet that has a packet duration that is equal to approximately 150 microseconds. The at least one processor 114 may be configured to transmit the RIM at a first transmission time that is approximately equal to a start time of the slot duration, and the difference between the slot duration and the packet duration defines a gap duration within the ranging slot. The at least one processor 114 may further be configured to receive a ranging response message (RRM) from the second UWB device within the gap duration of the ranging slot at a reception time that is after the start time of the slot duration plus the packet duration. In this example, the at least one processor 114 may be further configured to receive the RRM in the gap duration of the first ranging slot.

The at least one processor 114 may also be configured to retransmit the RIM based on a confidence metric, where the confidence metric may be a PSC (i.e., packet-specific confidence) metric value that corresponds to interference on at least the first ranging slot as measured by the second ranging device 102. In this example, the interference may be the result of a failure to receive the RIM at the second ranging device 102, or a low signal-to-interference and noise ratio (SINR) level or a figure-of-merit of the RIM received at the second ranging device 102. The at least one processor 114 may be configured to retransmit the RIM on the different ranging slot based on the PSC metric value being below a predefined threshold value.

Alternatively, the confidence metric may be a channel-specific confidence (CSC) metric value that corresponds to frequency-specific behavior over channels utilized for transmission of the RIM, and the CSC metric value may be based on the PSC metric value for different ranging slots.

In these examples, the channel hopping pattern may be a deterministic hopping pattern based on a predefined bitmap, or a random hopping pattern.

The circuits, components, modules, and/or devices of, or associated with the first ranging device 100 and second ranging device 102, and other devices are described as being in signal communication, communicatively coupled, and/or electrically coupled (or simply “coupled”) with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information may be passed from one circuit, component, module, and/or device to another in varying digital formats without passing through a direct electromagnetic connection.

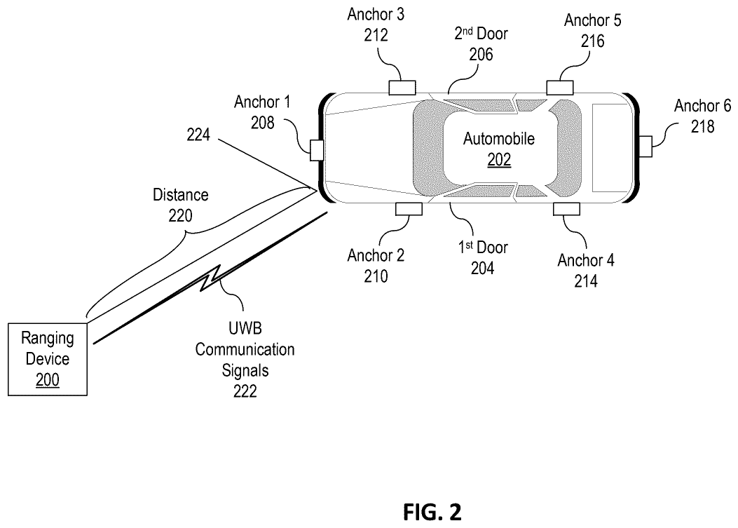

In FIG. 2, a system block diagram is shown of an example of an implementation of a ranging device 200 and a plurality of ranging devices (i.e., a cluster) acting as anchors conformally located around an automobile 202. In this example, the automobile 202 may include a first door 204 and second door 206 (on a first and a second side of the automobile 202) and the plurality of ranging devices may include, for example, six anchors that include a first anchor 208, second anchor 210, third anchor 212, fourth anchor 214, fifth anchor 216, and sixth anchor 218. As an example, the first anchor 208 and sixth anchor 218 may be located at the front and back of the automobile 202 and the second anchor 210 and fourth anchor 214 may be located on the first side of the automobile 202 and the third anchor 212 and fifth anchor 216 may be located on the second side of the automobile 202 opposite the first side. In this example, the second anchor 210 and the fourth anchor 214 may be located in front and in back of the first door 204 and the third anchor 212 and the fifth anchor 216 may be located in front and in back of the second door 206. In this example, as previously described, the six anchors are anchor devices (referred to herein as “anchors,” “UWB anchors,” or “tags”) that may include UWB devices with known locations that can be used to determine the position of the ranging device 200 using UWB signals. As an example, the UWB positioning may be performed utilizing relevant standards (e.g., IEEE 802.15.4ab), which enable high-accuracy, low-power positioning.

The ranging device 200 may be a key with a frequency operated button (generally referred to as a keyFOB or simply a “FOB”) that is utilized to unlock the first door 204 and second door 206 individually or together based on the distance 220 of the ranging device 200 to the automobile 202 and/or individual plurality of anchors based on the range (i.e., the distance 220) and location of the ranging device 200 relative to the automobile 202. In this example, the distance 220 between the automobile 202 and ranging device 200 is based on the measurements of the UWB communication signals 222 between the ranging device 200 and plurality of anchors.

In this example, the ranging device 200 may be, for example, a FOB and/or a module, component, or application of a mobile device such as, for example, a UE. With the known positions of the six anchors (i.e., first anchor 208, second anchor 210, third anchor 212, fourth anchor 214, fifth anchor 216, and sixth anchor 218), the determination of a location of the ranging device 200 can be made by determining the corresponding distances (not shown but approximately equal to the distance 220 between the ranging device 200 and a point 224 on the automobile 202 plus the individual distances from the point 224 to the locations of the individual anchors along the automobile 202) between the individual anchors and the ranging device 200. These distances (i.e., between the ranging device 200 and the individual anchors) can be determined using a variety of positioning-related measurements and/or procedures that may include, for example, Reference Signal Time Difference (RSTD), ToA (i.e., time of arrival), two-way ranging (TWR) (e.g., single-sided TWR (SS-TWR) and/or double-sided TWR (DS-TWR)), TDOA, and more. Additionally, or alternatively, angle-based measurements may also be made for positioning of the ranging device 200, including angle of arrival (AoA) and/or Angle of departure (AoD).

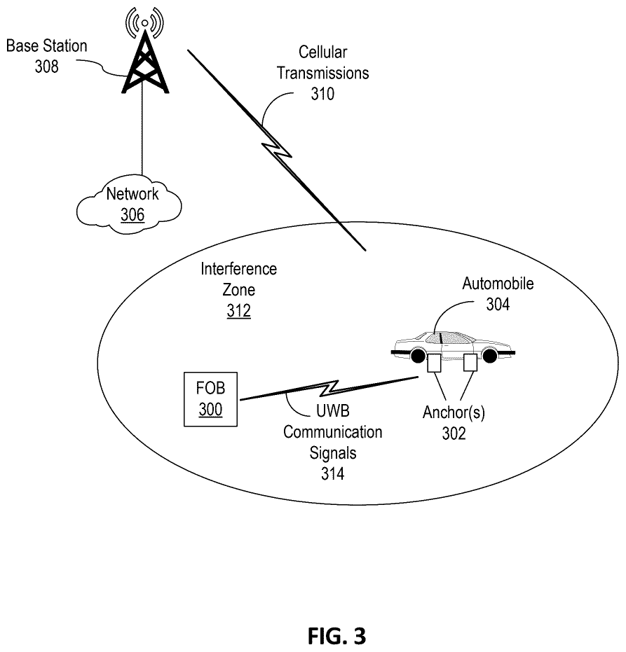

Turning to FIG. 3, a system block diagram is shown of an example of an implementation of a FOB 300 and a plurality of anchors 302 conformally located around an automobile 304. This example is similar to the example shown in relation to FIG. 2, except that in this example, the area around the FOB 300 and plurality of anchors 302 experiences signal interference from a cellular network 306. Specifically, the cellular network 306 is in signal communication with a cellular tower (i.e., a base station 308) that emits cellular transmissions 310 towards the area where both the FOB 300 and plurality of anchors 302 are located causing an interference zone 312 around the FOB 300 and plurality of anchors 302. In this example, the cellular transmission 310 cause interference (within the interference zone 312) with the UWB communication signal 314 between the FOB 300 and plurality of anchors 302.

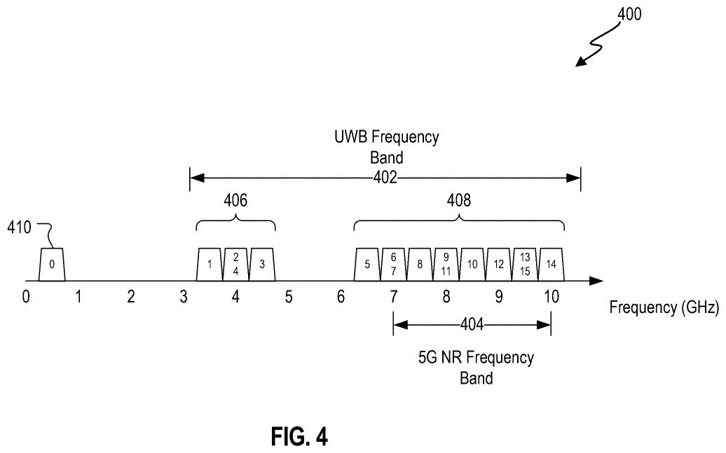

In FIG. 4, a frequency plot 400 is shown of UWB frequency band 402 and future 5G next radio (NR) frequency band 404. In this example, the UWB frequency band 402 (from 3.1 GHz to 10.6 GHz) contains channels 1-14 within a low band 406 and a high band 408, respectively, with the UWB frequency band 402 being well above a sub-GHz band 410 and the channels 1-14 spanning respective frequency bands. In this example, the future 5G NR frequency band 404 is shown to span UWB channels 6-15 of the high band 408.

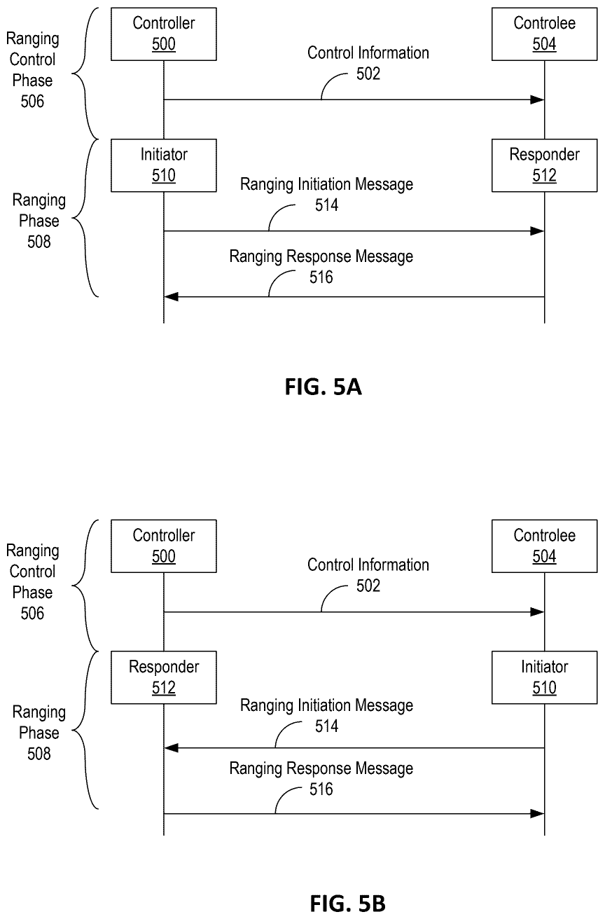

FIG. 5A is a message flow diagram illustrating the roles different devices may assume with regard to a UWB ranging session (or simply a “UWB session” or “ranging session”), which may be conducted in accordance with a relevant UWB positioning standard (e.g., IEEE 802.15.4ab). As discussed earlier, each UWB device may be a ranging device. The ranging devices may be referred to with different terminologies (e.g. initiator/responder or controller/controlee) at different layers of the network stack. The terms initiator and responder (described hereafter) may be used at lower layers (e.g., at UWB physical (PHY) and media access control (MAC) layers), while the terms controller and controlee (also described hereafter) may be used at higher layers (e.g., an application layer of the ranging devices).

In this example, the controller is a ranging device that controls the ranging and defines the ranging parameters by sending an RCM (i.e., the Ranging Control Message). In general, the RCM may be a data packet utilized for control purpose that could be transmitted via the UWB communication signals 104 (shown in FIG. 1) or over another narrow band signal such as, for example, the OOB signal 134 (shown in FIG. 1) that may be, for example, BLUETOOTH® or Wi-Fi®. The ranging parameters may be updated during an ongoing ranging session by sending a Ranging Control Update Message (RCUM). The controlee is a ranging device that utilizes the ranging parameters received from the controller in the RCM. Once the control message is provided to the controlee, both the controller and controlee know when to transmit a UWB packet and over what channel.

The initiator is a ranging device that following the RCM, initiates a ranging exchange by sending the first message of the exchange which is the RIM (i.e., the ranging initiation message). In this example, the initiator may be the controller or a controlee. The responder is a ranging device that responds to the ranging initiation message received from the initiator, with a ranging response message (RRM).

As indicated, for a pair of ranging devices communicating with each other, the controller 500 is a ranging device that sends control information 502 to a receiving ranging device, designated as the controlee 504 in a ranging control phase 506. The control information 502 may include parameters for the UWB ranging session, such as timing, channel, etc. Although not illustrated, the controlee 504 can send an acknowledgment to the control information 502, may negotiate changes to the parameters, and/or the like.

The exchange between controller 500 and controlee 504, including the sending of the control information 502 and subsequent related exchanges between the controller 500 and the controlee 504 regarding control information, may be conducted OOB using different wireless communication technology (e.g., BLUETOOTH® or Wi-Fi®), prior to a ranging phase 508. Specifically, a UWB session may be associated with a control phase and a ranging phase, where the control phase (which may take place on an OOB link) comprises a preliminary exchange between controller 500 and controlee 504 of parameter values for the ranging phase, and the subsequent ranging phase includes the portion of the UWB session in which devices exchange messages within the UWB band for ranging measurements. It is appreciated, however, that some control information may be exchanged within the UWB band (e.g., a “ranging control phase” occurring in the first slot of a UWB round). Accordingly, some aspects of the control phase may be considered to occur in band, subsequent to the preliminary OOB exchange between the controller 500 and the controlee 504.

The UWB session may occur afterward, in accordance with the parameters provided in the control information. In the ranging phase of the UWB session, one ranging device may take the role of an initiator 510 and the other ranging device may take the role of a responder 512. As indicated in FIG. 5A, the initiator 510 may initiate UWB ranging by sending a ranging initiation message 514 to the responder 512, to which the responder 512 may reply with a ranging response message 516, and timing measurements may be made of these messages (by the devices receiving the messages) to perform two-way ranging (TWR). Depending on the parameters of the control information 502, additional exchanges may be made in the ranging phase between the initiator 510 and responder 512 to allow for additional ranging measurements.

In this example, the roles of initiator 510 and responder 512 may be indicated in the control information 502. Further, as indicated in FIG. 5A, the controller 500 in the ranging control phase 506 may be the initiator 510 in the ranging phase 508 of the UWB session. Alternatively, as indicated in FIG. 5B, the controller 500 in the ranging control phase 506 may be the responder 512 in the ranging phase 508. The determination of which device is initiator 510 and which is responder 512 may depend on the parameters set forth in the control information 502, in which case the controlee 504 correspondingly becomes either the responder 512 or the initiator 510. According to some embodiments, a controller/initiator may conduct ranging with multiple controlees/responders.

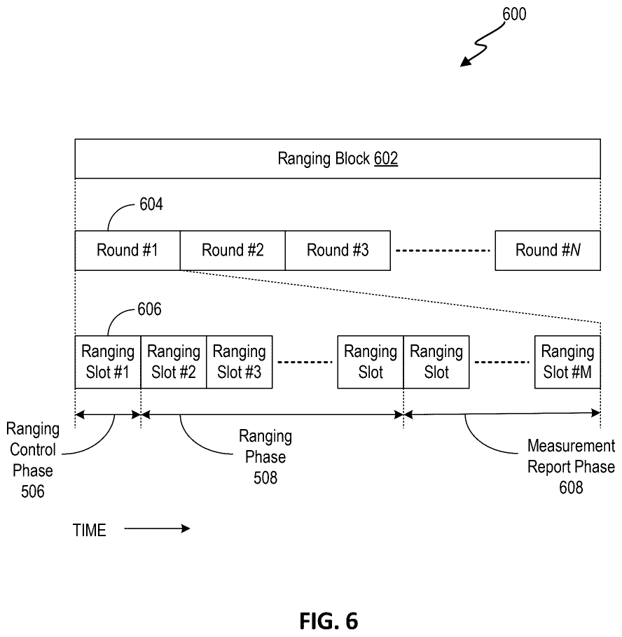

FIG. 6 is a diagram 600 illustrating how time may be segmented and utilized within a UWB positioning session, which may be used in some embodiments. A UWB session may occur over a period of time divided into sub-portions according to a hierarchical structure. This timing comprises one or more consecutive ranging blocks 602, which may have a configurable duration (e.g., 200 ms). For simplicity and ease of illustration, only one ranging block 602 is shown in FIG. 6. However, it is appreciated that a UWB session may utilize multiple blocks, which may occur in succession. Also, although called “ranging” blocks 602, they may be used for ranging and/or sensing. Each ranging block 602 may be split into one or more successive rounds 604 (e.g., N rounds). The number and length of the rounds may be configurable. The rounds 604 may be further split into different ranging slots 606 (also referred to simply as “slots”), which also may have a configurable number and length (e.g., 1-2.66 ms). As an example, multiple rounds may be used for interference handling. For example, a given responder may transmit a message (i.e., a data packet) within only a single round per block, and the round index may either be statistically configured by the controller 500 or selected per a hopping pattern. In general, the UWB session utilizing Time Division Multiplexing (TDM) communication for communicating between the different UWB devices based on the IEEE 802.15.4 standards for UWB.

The ranging slots within round 604 may be allocated for different purposes. For example, the initial ranging slot may be dedicated as the ranging control phase 506 (i.e., where the controller 500 transmits the RCM), in which an initiator UWB device (e.g., an initiator anchor), transmits control information for the other UWB devices participating in a UWB session (e.g., responder anchors and/or other UWB devices). This information can include, for example, an allocation of ranging slots among the different responder devices. During the subsequent ranging phase 508, the different responder may transmit in accordance with the allocated slot. That is, each responder may be allocated a corresponding slot in the ranging phase 508 to transmit one or more ranging/sensing signals. In this example, a ranging packet duration may utilize the SP3 format that is about 150 microseconds such that the remainder of the slot (i.e., a “gap”) may be retained for processing delays and/or reply messages such as RRM.

The ranging phase 508 may be followed by a measurement report phase 608 in which UWB anchors in a cluster may report measurements (e.g., of signals measured during the ranging phase 508). Sequential ranging slots may be used to perform Single-Sided Two-Way Ranging (SS-TWR) or DS-TWR, for example. Multiple UWB sessions can be time-multiplexed to help prevent interference with one another.

In general, the RIM and RRM include preambles and data sequences that can be correlated to get TOA values. In these examples, the individual ranging slots 606 are utilized for transmission of ranging packets and the first ranging slot (i.e., ranging slot #1) is reserved for the RCM. In this example, only a single ranging round 604 is selected within ranging block 602 and the other ranging rounds may be idle. This helps prevent interference from multiple UWB seasons operating in the vicinity so as to reduce the likelihood of interference.

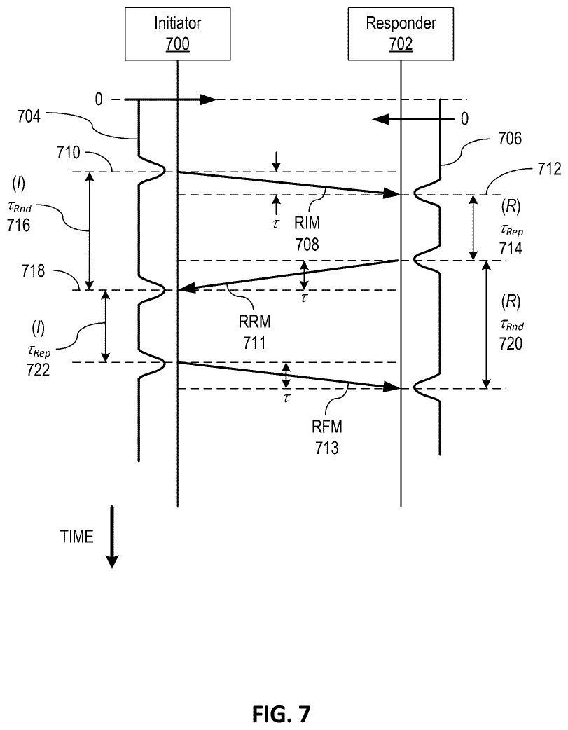

FIG. 7 is a signal flow diagram of communications between the first ranging device (acting as an initiator 700) and the second ranging device (acting as a responder 702) in accordance with the present disclosure. In this example, the initiator 700 is shown transmitting and receiving signals 704 and the responder 702 is shown receiving and transmitting signals 706. The pulses shown on the signals 704 and 706 illustrate the timing of transmissions between the initiator 700 and responder 702.

In general, the there is a lag between the first signal 704 and second signal 706 as shown with the “0” marked on the first signal 704 as compared to the “0” marked on the second signal 706 that are not aligning. This means that the “0” that the initiator 700 maintains in its local clock (i.e., its local time reference) is lagging the local reference that the responder 702 maintains. As such, when an TOA estimate is generated it will have an error called a “clock offset” error. In addition to the clock offset error, this example of operation also generally introduces a carrier frequency offset/error that is related to the modulation frequency acting on the carrier frequency of operation of the channel that both the initiator 700 are responder 702 are utilizing. In general, the use of a third data packet message will eliminate these problems by utilizing DS-TWR. In this example, the third data packet message may be Reply Final Message (RFM) which is a RRM.

FIG. 7 illustrates the impact of carrier frequency offset on TOA estimations because there is a time delay (τ) between the signals 704 from the initiator 700 reaching the responder 702 and the signals 706 from the responder 702 reaching the initiator 700. Specifically, an RIM 708 transmitted as part of the signal 704 (as shown by the pulse at a first time 710) reaches the responder 702 at a second time 712 (as shown by the pulse on the signal 706) that is delayed by a propagation delay τ. Likewise, both the RRM 711 and RFM 713 are each also delay τ. As such, if the responder 702 has transmission delay (τᵣₑₚ) 714 in responding with the RRM 711 after receiving the RIM 708, the round-trip time (τ_{Rnd}) 716 from the transmission of the RIM 708 at the first time 710 to the time 718 that the RRM 711 is received by the initiator 700 is the summation of the τᵣₑₚ 714 plus twice the propagation delay τ. Similarly, the round-trip time (τ_{Rnd} 720) from the time that RRM 711 is transmitted to the initiator 700 and a ranging final message (RFM) 713 is received from the initiator is the summation of the transmission delay (τᵣₑₚ 722) of the initiator 700 plus twice the propagation delay τ. With these values, both the SS-TWR and DS-TWR may be calculated. Additionally, the relative clock drift rate, initiator carrier frequency error, responder carrier frequency error may also be calculated.

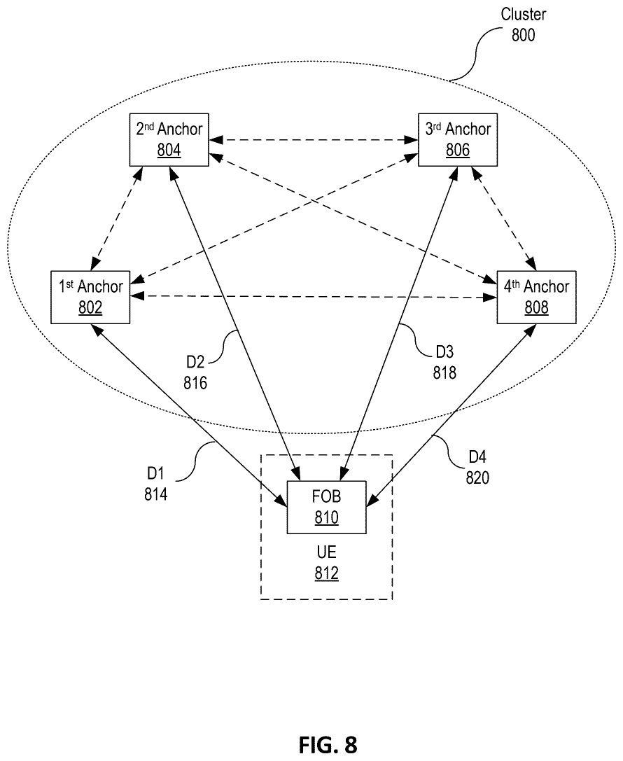

In FIG. 8, a functional system block diagram illustrating an example of a cluster 800 of anchors is shown in accordance with the present disclosure. In this example, cluster 800 may include, for example, four anchors (i.e., first anchor 802, second anchor 804, third anchor 806, and fourth anchor 808) that are in signal communication with each other and with the FOB 810 that may be, for example, a part of an optional UE 812. In this example, the four anchors can determine the location of a FOB 810 using ranging to determine values for distances D1 814, D2 816, D3 818, and D4 820, based on known UWB ranging techniques. In particular, the cluster 800 may allow for the positioning of the FOB 810 using TDOA measurements in UWB. Specifically, the FOB 810 can, for each anchor in the cluster 800, precisely measure the reception time of a message (e.g., downlink TDOA messages) sent by the anchor. Using reception times and obtained coordinates of the anchors, the FOB 810 may estimate its position. For a cluster 800 providing the TDOA, the FOB 810 and anchors of a cluster 800 may be respectively referred to as a downlink TDOA (DT)-tag and DT-anchors. In this example, the positioning supported by a cluster 800 made in accordance with applicable standards by FiRa™, the standards organization comprising a consortium of multiple member entities developing standards for UWB ranging and positioning.

In this example, the cluster 800 may be a set of anchors (i.e., first anchor 802, second anchor 804, third anchor 806, and fourth anchor 808) that exchange messages with each other to provide a localization service. As an example, OOB messaging (e.g., OOB configuration messages sent via BLUETOOTH® or Wi-Fi) may be sent by an Init-anchor (e.g., first anchor 802) to create the cluster 800 of anchors within a cluster area. To support TDOA positioning, the anchors may provide ranging messages with each other to provide TDOA localization to DT-tags.

FIG. 9 is a signal time diagram illustrating how a first message 900 is transmitted and a second message 902 is received within a ranging slot 904 of the ranging slots 606 (shown in FIG. 6). In this example, ranging slot 904 has a ranging slot duration 906 with a ranging slot start-time 908 and ranging slot end-time 910. As described previously, when the first message 900 is transmitted, it is transmitted close the ranging slot start-time 908 and ends at end-time 912. The ranging slot gap 914 is defined as the time difference between end-time 912 of the first message 900 and the end-time 910 of the ranging slot 904. Moreover, the difference between the slot duration 906 and packet duration 916 of the first message 900 defines the slot gap 914 duration within the ranging slot 904.

As an example, if the packet duration 916 of the first message 900 is, for example, 150 microseconds, and ranging slot duration 906 is between 1 ms to 2.66 ms, the ranging slot gap 914 would be approximately 850 microseconds to 2.51 ms assuming that the start-time of the first message 900 is approximately at the start-time 908 of the ranging slot 904. The second message 902 (i.e., a reply message) may have a start-time 918 somewhere after the end-time 912 of the first message 900 within the ranging slot gap 914 duration.

Turning to FIG. 10, a functional block diagram is shown of an example of communication between the first ranging device and a plurality of ranging devices in accordance with the present disclosure. In general, FIG. 10 illustrates a UWB message sequence in the case of multiple responders. As an example in a vehicle 1040 (e.g., automobile 202), the vehicle 1040 may include five anchors (i.e., UWB transceivers) to allow the determination of a UE/FOB (e.g., a mobile device 1000) to be estimated with respect to the vehicle utilizing seven ranging message for DS-TWR. This approach may enable applications that, for example, unlock a specific door as a user of the UE/FOB approaches the vehicle 1040.

In this example, the mobile device 1000 acts as an initiator 1002 that transmits and receives ranging messages 1004, 1006, 1008, 1010, 1012, 1014, 1016, 1018, and 1020 on the first ranging slot 1022, second ranging slot 1024, third ranging slot 1026, fourth ranging slot 1028, fifth ranging slot 1030, sixth ranging slot 1032, seventh ranging slot 1034, eighth ranging slot 1036, and ninth ranging slot 1038, respectively. Each anchor on the vehicle 1040 may act as a responder 1042 that transmits and receives ranging messages 1044, 1046, 1048, 1050, 1052, 1054, 1056, 1058, and 1060 on the first ranging slot 1022, second ranging slot 1024, third ranging slot 1026, fourth ranging slot 1028, fifth ranging slot 1030, sixth ranging slot 1032, seventh ranging slot 1034, eighth ranging slot 1036, and ninth ranging slot 1038, respectively. In this example, for the initiator 1002, the transmit ranging messages 1004, 1006, 1018, and 1020 may be an RCM 1062 for the first ranging message 1004 on the first slot 1022, a final-data MRM (i.e., a measurement report message) 1064, and transmit messages 1006 and 1018 and receive messages 1008, 1010, 1012, 1014, and 1016 may be a plurality of ranging messages for DW-TWR determination 1066. Specifically, the transmit messages 1006 and 1018 may be RIMs and the receive messages 1008, 1010, 1012, 1014, and 1016 may be RRMs.

For the responder 1042, the response message 1044 is an RRM that is transmitted in the first slot 1022 in response to receiving the RCM 1062 of the first transmit message 1004. As was previously discussed and referring to FIG. 9, the RRM (i.e., response message 1044) is transmitted back by the responder 1042 to the initiator 1002 within the slot gap 1068 with a reply start-time (i.e., start-time 918) that is after a packet duration (i.e., packet duration 916) of the first transmit message 1004. In this example, the original slot gap 1068 may be reduced to a new slot gap 1070 that is less than the original slot gap 1068 because of the package duration of the RRM. The ninth message 1060 may be an RRM of the MRM transmitted by the ninth transmit message 1020 on the ninth ranging slot 1038. The transmit ranging messages 1048, 1050, 1052, 1054, and 1056 may be RRMs for the corresponding ranging messages 1008, 1010, 1012, 1014, and 1016, on the third slot 1026, fourth slot 1028, fifth slot 1030, sixth slot 1032, and seventh slot 1034 received by the initiator 1002. In this example, as discussed previously, the received ranging messages 1008, 1010, 1012, 1014, and 1016 may be received within the original slot gaps 1072, 1074, 1076, 1078, and 1080, of the third slot 1026, fourth slot 1028, fifth slot 1030, sixth slot 1032, and seventh slot 1034, respectively resulting in new slot gaps 1082, 1084, 1086, 1088, and 1090, respectively. The received second ranging message 1046, in the second ranging slot 1024, and the third received ranging message 1058, in the eighth ranging slot 1036, are received RIMs corresponding to the transmitted second ranging message 1006 and third ranging message 1018 in the third and eighth ranging slots 1026 and 1036. Again, the received second ranging message 1046 and third received ranging message 1058 are received within the original slot gaps 1092 and 1094, resulting in new slot gaps 1096 and 1098, respectively.

In this example, a single channel is utilized by both the initiator 1002 and responder 1042. If a channel change is desired (e.g., to help reduce interference), a ranging control update message (RCUM) may be transmitted by either the initiator 1002 or the responder 1042. The RCUM is generally an RCM, but it is not transmitted during the ranging control phase (i.e., ranging control phase 506 of FIGS. 5A, 5B, and 6). The RCUM would be transmitted on the last ranging slot (i.e., either the eighth ranging slot 1036, or optionally, the ninth slot 1038—i.e., the MRM slot 1064) of the current ranging round of the ranging phase (i.e., the ranging phase 508 of FIGS. 5A, 5B, and 6). The change of channel would then take effect in the subsequent ranging round of the next ranging block (i.e., a ranging block after ranging block 602 of FIG. 6).

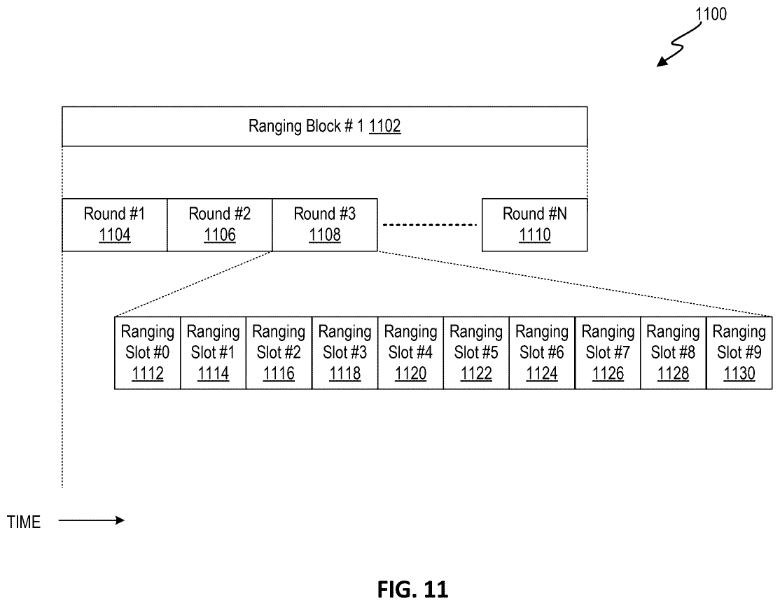

FIG. 11 is a functional block diagram 1100 of an example of communication between the first ranging device and the second ranging device utilizing slot-by-slot channel hopping within the same ranging round (i.e., first ranging block 1102) in accordance with the present disclosure. Similar to the diagram 600 shown in FIG. 6, the first ranging block 1102 includes one or more successive ranging rounds 1104, 1106, 1108, and 1110 (e.g., N ranging rounds). Again, the number and length of the ranging rounds may be configurable. The ranging rounds may be further split into different ranging slots, which also may have a configurable number and length (e.g., 1-2.66 ms). As an example, the third ranging round 1108 may be split into ten (10) ranging slots 1112, 1114, 1116, 1118, 1120, 1122, 1124, 1126, 1128, and 1130.

In this example, the first ranging device and second ranging device (acting as a controller and controlee) may agree on a retransmission schedule/strategy by performing channel hopping within a ranging round (e.g., the third ranging round 1108), e.g., based on a confidence metric that corresponds to interference on at least the first ranging slot as measured by a second UWB device (which may be either the first ranging device or second ranging device acting as a responder). The PSC (i.e., packet-specific confidence) metric represents a confidence metric of the measured impact of interference (e.g., which may be from IMT or another UWB session) in the vicinity (e.g., the interference zone 106 of FIG. 1) of the first ranging device and second ranging device. The PSC metric value may be based, for example, on the failure to receive the corresponding packet, SINR level, or TOA estimation quality (also known as figure-of-merit) from transmitted messages between the first ranging device and second ranging device.

As such, described is a retransmission strategy for UWB, where channel hopping is performed on a slot-by-slot basis within the same ranging round and is based on feedback between the UWB devices (i.e., the first ranging device and second ranging device). The retransmission strategy may have low latency that may be achieved through retransmission of ranging packets within the same round (e.g., on the order of 10-20 ms) as opposed to waiting for the next ranging block (e.g., up to 200 ms later) to perform ranging.

In this example, the UWB devices implement this retransmission strategy but having the controller schedule a ranging session with the controlee. The controller schedules the ranging session by providing configuration information to the controlee in the RCM that is transmitted to the controlee. In this example, the RCM may include information pertaining to an indication as to whether slot-specific channel hopping is enabled or disabled and if the slot-specific channel hopping is enabled, providing the controlee with a set of channels that the devices may hop over to. The controller may also provide the controlee (via the RCM) with the PSC metric value to be used and an associated formulation and a predetermined threshold level value which would trigger a channel hopping event.

In this example, the predetermined threshold may be pre-determined and provided by the controller to the controlee (as was discussed previously). The controller may be pre-programmed to use a predetermined threshold value. The PSC metric value may be a function of, for example, one or more of the following—packet error rate, SINR level, or figure-of-merit. The hopping event may be triggered when these thresholds are exceeded as previously discussed.

If the PSC metric value is utilized to trigger the channel hopping event, the responder may respond back to the initiator by sending a “indicator packet” that indicates to the initiator that the threshold has been triggered and that the hopping schedule will begin. In this example, similar to the RCM, the indicator packet may be sent back within the same ranging slot within the ranging slot gap or via an OOB such as, for example, BLUETOOTH® or Wi-Fi. In general, the indicator packet could be an indication via a RRM that the RIM needs to be retransmitted. Examples that might trigger the predetermined threshold may include, for example, a measured SNIR that may be below 3 dB.

In this example, the channel hopping patterns are provided by the controller to the controlee. When a channel hopping event is triggered, the devices begin to follow the hopping schedule and before the triggered event, the devices, for example, may not have been utilizing any hopping at all.

If the PSC metric value is used to trigger a channel hop, an indication to perform the channel hop may be sent by the responder to the initiator over OOB prior to the start of the next ranging slot. In this example, the OOB packet may be transmitted back (and expected by the initiator) after a fixed and known offset within the ranging slot. Alternatively, the indication may only be provided later in the next occurring ranging message packet.

Alternatively, the channel hopping pattern may instead be based on a confidence metric that includes a CSC (i.e., a channel-specific confidence) metric value. Qualitatively, the CSC captures the frequency-specific behavior of the IMT (e.g., 5G NR and/or 6G) interference. In this example, the initiator and the one or more responders may both maintain and update a CSC metric that evolves over the duration of a ranging round (with each ranging slot). The CSC metric is a confidence metric that may be a function of the PSC metric value that is observed over multiple ranging slots.

As an example of operation, the initiator may transmit an RCM in the initial ranging slot 1112 that indicates to the one or more responders to utilize a specific deterministic hopping pattern. The initiator may then transmit an RIM (i.e., its ranging message) utilize channel 9 in the first ranging slot 1114. In the second ranging slot 1116, the first responder sends back a ranging message comprising the PSC metric, which may be used by the initiator to update and maintain a CSC metric for channel 9. In this example, at the cluster of anchors acting as the one or more responders (e.g., at a vehicle), the other responders may be notified of the same CSC metric for channel 9 (using the same formulation/computation strategy that is used by the initiator). This process may be repeated for various channels such that a CSC metric is found for multiple channels. In subsequent ranging rounds, once a set of CSC metric values have been inferred and stored by the initiator, the initiator may enable CSC-metric based channel hopping and transmit the current CSC metric values in the form of a bitmap. It is appreciated that these confidence metric values can continue to evolve over time. As such, utilizing this process, the PSC metric value may be initially determined for a certain channel but over time, the PSC metric values may be utilized to generate the CSC metric values which can then be utilized instead of the PSC metric value as the confidence metric.

As another example of operation, the initiator may transmit the RCM in the initial ranging slot 1112 that indicates to the one or more responders (i.e., the anchors) to utilize a specific deterministic hopping pattern. The initiator may then transmit an RIM on channel 9 in the first ranging slot 1114 and then waits for one or more RRMs from the one or more responders. In this example, in the second ranging slot 1116, the initiator does not successfully receive an RRM from a first responder (or is under confident about the TOA estimation quality of the received RRM) over channel 5. In this example, the initiator then updates a CSC metric for channel 5, while the responders internally update a metric for channel 9. In the third ranging slot 1118, the initiator successfully receives an RRM from a second responder and updates a CSC metric for channel 13 and the PSC metric value for channel 9 that was received by the first responder. As this process repeats, at the end of the first ranging block 1102, the initiator has gathered the CSC metric values for the various channels.

In this example, the channel hopping pattern may be a deterministic hopping pattern based on a predefined bitmap, or a random hopping pattern. As an example, if the channel hopping pattern is deterministic, a bitmap may indicate the channel to be used in a corresponding slot. For example, the bitmap {1001|0101|1101| . . . } may indicate, for example, that channels 9, 5, and 13 are to be used in the first, second, and third ranging slots respectively. In this example, the ordering of the bits in the bitmap may refer implicitly to the slot index of the ranging slots. Alternatively, if the channel hopping pattern is a random hopping pattern, the channel hopping pattern may be generated by a random number generator (or function) for a pseudo-random pattern that may be utilized by both the controller and controlee. In this example, the controller and controlee are synchronized in generating the random hopping pattern.

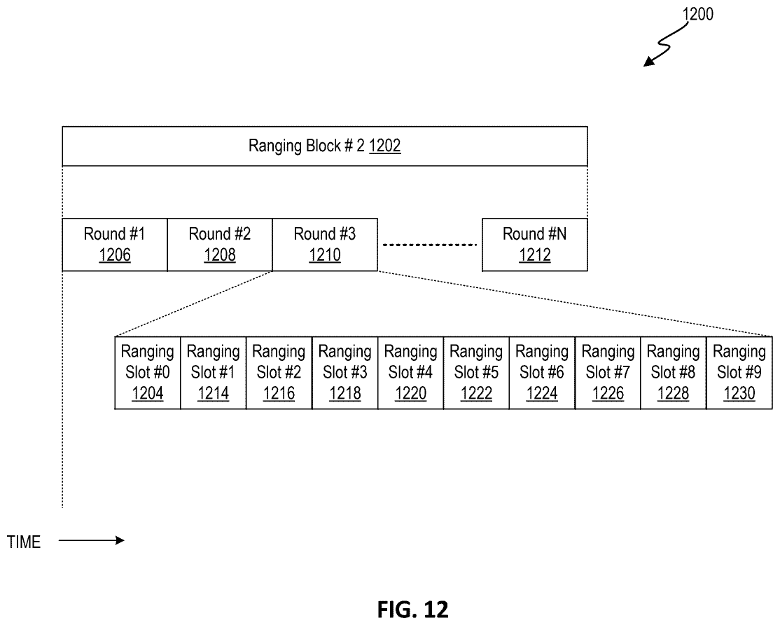

FIG. 12 is a functional block diagram 1200 of another example of communication between the first ranging device and the second ranging device utilizing slot-by-slot channel hopping within the same ranging round in accordance with the present disclosure. In this example, the CSC metric values have been previously determined for the various channels in the first ranging block 1102 (as described in FIG. 11). In the second ranging block 1202, the initiator transmits an RCM on the initial ranging slot 1204, where the RCM indicates to the one or more responders to use a channel hopping pattern based on the CSC metric values which were previously determined in the first ranging block 1102. The CSC metric values may be transmitted to the one or more responders as a bitmap.

Similar to the example described in relation to FIG. 11, in this example, the second ranging block 1202 includes N successive ranging rounds (i.e., first ranging round 1206, second ranging round 1208, third ranging round 1210, through N^{th} ranging round 1212) and the third ranging round 1210 includes ten (10) ranging slots (i.e., initial ranging slot 1204, first ranging slot 1214, second ranging slot 1216, third ranging slot 1218, fourth ranging slot 1220, fifth ranging slot 1222, sixth ranging slot 1224, seventh ranging slot 1226, eighth ranging slot 1228, and ninth ranging slot 1230).

The initiator then transmits an RIM on channel 9 on the first ranging slot 1214 and successfully receives an RRM from the first responder on the second ranging slot 1216. On the third ranging slot 1218, the initiator does not successfully receive an RRM from the second responder and chooses to select channel 13 that has the next best CSC metric. Prior to the start of fourth ranging slot 1220, the initiator may transmit an OOB packet (e.g., BLUETOOTH® or Wi-Fi) to the one or more responders to indicate that the packet was dropped and a channel hop should be performed. Alternatively, the indication that the packet was dropped may, instead, be included in the next occurring ranging message as opposed to an OOB packet.

While in these examples, the initiator has been configured to retransmit the RIM on a different ranging slot utilizing the channel hopping pattern based on a confidence metric, in other examples, the retransmission of the RIM need not be based on a confidence metric. In other examples, the channel hopping pattern may always be continuously performed by the controller and controlee. Additionally, in situations where it is determined that certain channels are experiencing constant, or almost constant, interference, the channel hopping pattern may be established and/or modified to hop in a way that avoids that type of interference.

As an example of operation, the devices may initially transmit on a common channel, say channel 9. When a threshold related to a confidence metric is met, the hopping sequence is triggered, and both devices may follow a channel hopping pattern across the slots (such as a deterministic one). As an alternative example, both devices may follow a channel hopping pattern from the very first slot and across all slots.

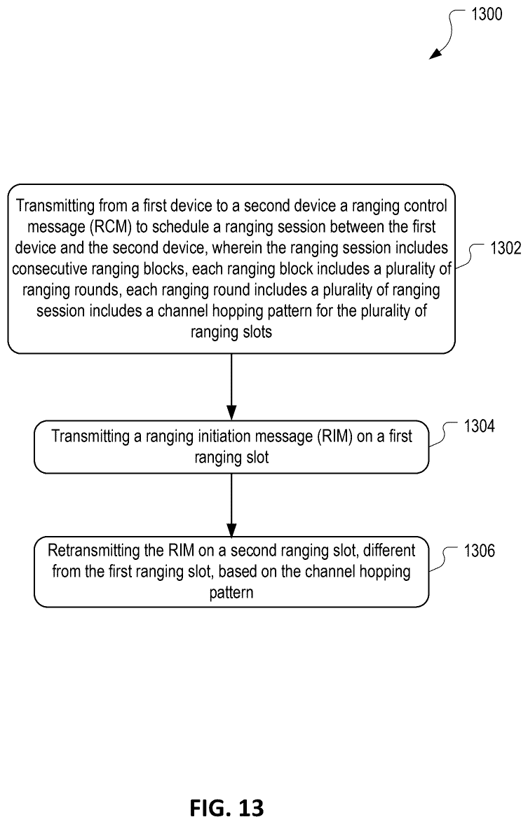

FIG. 13 is a flowchart of an example of an implementation of a method 1300 for avoiding interference with an UWB device. The method includes transmitting, with an at least one transceiver (i.e., at least one transceiver 110 or at least one transceiver 116) 1302, an RCM to schedule a UWB ranging session with a second UWB device; transmitting 1304 a RIM on a first ranging slot; and retransmitting the RIM on a second ranging slot, different from the first ranging slot, utilizing the channel hopping pattern. In this example, the UWB ranging session may include a plurality of consecutive ranging blocks, where each ranging block includes a plurality of ranging rounds, and each ranging round includes a plurality of ranging slots. The schedule may include the channel hopping pattern for the plurality of ranging slots.

As an example, each ranging slot may have a slot duration (e.g., slot duration 906), the RIM includes a data packet (e.g., message 900) that has a packet duration (e.g., packet duration 916) that is shorter than the slot duration (e.g., slot duration 906). For example, each ranging slot (e.g., ranging slot 904) may have a slot duration that is equal to between approximately 1 millisecond and approximately 2.66 milliseconds, and the RIM includes a data packet that has a packet duration that is equal to approximately 150 microseconds.

Transmitting RIM on the first ranging slot may include transmitting the RIM at a first transmission time that is approximately equal to a start time (e.g., start-time 908 of the slot) of the slot duration (e.g., slot duration 906), and the difference between the slot duration and the packet duration may define a gap duration (e.g., slot gap 914) within the ranging slot (e.g., ranging slot 904). The method 1300 may further include receiving an RRM from the second UWB device within the gap duration of the ranging slot at a reception time (e.g., start-time 918 of the reply) that is after the start-time of the slot duration plus the packet duration. The method 1300 may also further include receiving the RRM in the gap duration of the first ranging slot. As an example, the retransmission of the RIM may be based on a confidence metric.

The confidence metric may be a PSC metric value that corresponds to interference on at least the first ranging slot as measured by the second UWB device. In this example, the interference may be the result of a failure to receive the RIM at the second UWB device, or a low SINR level or a figure-of-merit of the RIM received at the second UWB device. As an example, the retransmission of the RIM on the different ranging slot is based on the PSC metric value being below a predefined threshold value. Alternatively, the confidence metric may be a CSC metric value that corresponds to frequency-specific behavior over channels utilized for transmission of the RIM, and the CSC metric value may be based on the PSC metric value for different ranging slots. In this example, the channel hopping pattern may be a deterministic hopping pattern based on a predefined bitmap, or a random hopping pattern.

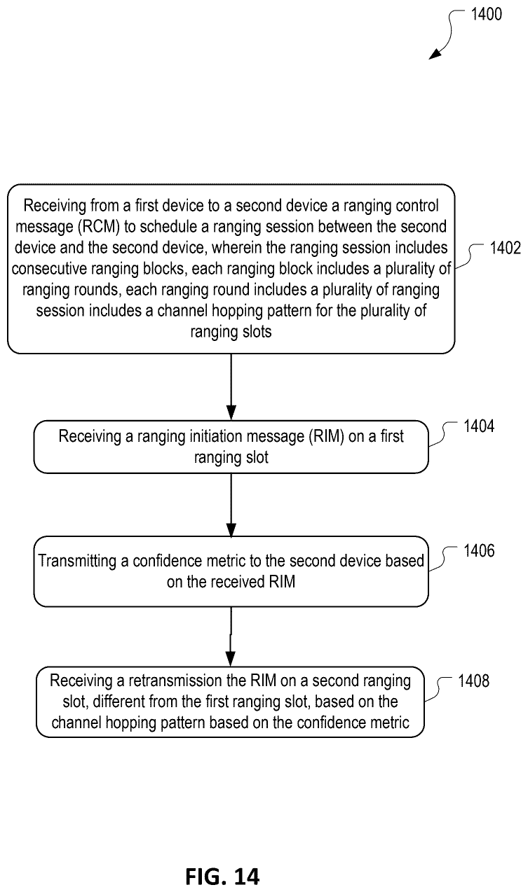

FIG. 14 is a flowchart of another example of an implementation of a method 1400 for avoiding interference with a UWB device. In this example, the method 1400 is for avoiding interference with a UWB device where, unlike the example described in relation to FIG. 13, the UWB device in this example is a responder (i.e., responder 702). The UWB device may be an anchor (e.g., one of the anchors shown in FIG. 8) or another UWB device that may include another UE or other UWB device. The method 1400 comprises: at 1402, receiving an RCM to schedule a UWB ranging session from a second UWB device (e.g., a UE and/or FOB 300), wherein the UWB ranging session includes a plurality of consecutive ranging blocks, each ranging block includes a plurality of ranging rounds, each ranging round includes a plurality of ranging slots, and the schedule includes a channel hopping pattern for the plurality of ranging slots; at 1404, receiving a RIM on a first ranging slot; at 1406, transmitting a confidence metric to the second UWB device based on the received RIM; and at 1408, receiving a retransmission of the RIM on a second ranging slot, different from the first ranging slot, utilizing the channel hopping pattern based on the confidence metric.

As previously discussed, the confidence metric may be a packet-specific confidence PSC metric value that corresponds to interference on at least the first ranging slot as measured by the UWB device, where the confidence metric may indicate a failure to receive the RIM at the UWB device, or a low signal-to-interference and noise ratio (SINR) below a SINR threshold, or a figure-of-merit of the RIM received at the UWB device. In this example, receiving the retransmission of the RIM my include receiving the retransmission of the RIM on the different ranging slot based on the PSC metric value being below a predefined threshold value.

Moreover, the confidence metric may be, or include, a channel-specific confidence CSC (a channel-specific confidence) metric value that corresponds to frequency-specific behavior over channels utilized for transmission of the RIM, and the CSC metric value may be based on the PSC metric value for different ranging slots. In this example, the channel hopping pattern may be a deterministic hopping pattern based on a predefined bitmap, or a random hopping pattern.

### IMPLEMENTATION EXAMPLES

Implementation examples are provided in the following numbered clauses.

Clause 1. A device for avoiding interference, the device comprising: at least one transceiver; at least one memory; and at least one processor, in signal communication with the at least one transceiver, and the at least one memory, the at least one processor configured to: transmit, with the at least one transceiver, a ranging control message (RCM) to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; transmit a ranging initiation message (RIM) on a first ranging slot; and retransmit the RIM on a second ranging slot, different from the first ranging slot, based on the channel hopping pattern.

Clause 2. The device of clause 1, wherein each ranging slot has a slot duration, the RIM includes a data packet that has a packet duration that is shorter than the slot duration, the at least one processor is configured to transmit the RIM at a first transmission time that is approximately equal to a start time of the slot duration, and the difference between the slot duration and the packet duration defines a gap duration within the ranging slot.

Clause 3. The device of clause 2, wherein the at least one processor is further configured to receive a ranging response message (RRM) from the second device within the gap duration of the ranging slot at a reception time that is after the start time of the slot duration plus the packet duration.

Clause 4. The device of clause 3, wherein the at least one processor is further configured to receive the RRM in the gap duration of the first ranging slot.

Clause 5. The device of clauses 1, 2, 3, or 4, wherein the at least one processor is configured to retransmit the RIM based on a confidence metric that includes either a packet-specific confidence (PSC) metric value or a channel-specific confidence (CSC) metric value.

Clause 6. The device of clause 5, wherein the PSC metric value corresponds to interference on at least the first ranging slot as measured by the second device.

Clause 7. The device of clause 6, wherein the confidence metric indicates a failure to receive the RIM at the second device, or a low signal-to-interference and noise ratio (SINR) below a SINR threshold, or a figure-of-merit of the RIM received at the second device.

Clause 8. The device of clause 6, wherein the at least one processor is configured to retransmit the RIM on the different ranging slot based on the PSC metric value being below a predefined threshold value.

Clause 9. The device of clause 6, wherein the CSC metric value corresponds to frequency-specific behavior over channels utilized for transmission of the RIM, and the CSC metric value is based on the PSC metric value for different ranging slots.

Clause 10. The device of clauses 1, 2, 3, 4, 5, 6, 7, 8, or 9, wherein the channel hopping pattern is a deterministic hopping pattern based on a predefined bitmap, or a random hopping pattern.

Clause 11. A method for avoiding interference with a device, the method comprising: transmitting, with an at least one transceiver, a ranging control message (RCM) to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; transmitting a ranging initiation message (RIM) on a first ranging slot; and retransmitting the RIM on a second ranging slot, different from the first ranging slot, based on the channel hopping pattern.

Clause 12. The method of clause 11, wherein each ranging slot has a slot duration, the RIM includes a data packet that has a packet duration that is shorter than the slot duration, transmitting the RIM at a first transmission time that is approximately equal to a start time of the slot duration, and the difference between the slot duration and the packet duration defines a gap duration within the ranging slot.

Clause 13. The method of clause 12, further comprising receiving a ranging response message (RRM) from the second device within the gap duration of the ranging slot at a reception time that is after the start time of the slot duration plus the packet duration.

Clause 14. The method of clause 13, further comprising receiving the RRM in the gap duration of the first ranging slot.

Clause 15. The method of clauses 11, 12, 13, or 14, wherein retransmitting the RIM is based on a confidence metric that includes either a packet-specific confidence (PSC) metric value or a channel-specific confidence (CSC) metric value.

Clause 16. The method of clause 15, wherein the PSC metric value corresponds to interference on at least the first ranging slot as measured by the second device.

Clause 17. The method of clause 16, wherein the confidence metric indicates a failure to receive the RIM at the second device, or a low signal-to-interference and noise ratio (SINR) below a SINR threshold, or a figure-of-merit of the RIM received at the second device.

Clause 18. The method of clause 16, wherein retransmitting the RIM on the different ranging slot is based on the PSC metric value being below a predefined threshold value.

Clause 19. The method of clause 16, wherein the CSC metric value corresponds to frequency-specific behavior over channels utilized for transmission of the RIM, and the CSC metric value is based on the PSC metric value for different ranging slots.

Clause 20. The method of clauses 11, 12, 13, 14, 15, 16, 17, 18, or 19, wherein the channel hopping pattern is a deterministic hopping pattern based on a predefined bitmap, or a random hopping pattern.

Clause 21. An Ultra-wideband (UWB) device for avoiding interference, the device comprising: means for transmitting a ranging control message (RCM) to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; means for transmitting a ranging initiation message (RIM) on a first ranging slot; and means for retransmitting the RIM on a second ranging slot, different from the first ranging slot, based on the channel hopping pattern

Clause 22. The device of clause 21, wherein each ranging slot has a slot duration, the RIM includes a data packet that has a packet duration that is shorter than the slot duration, means for transmitting the RIM at a first transmission time that is approximately equal to a start time of the slot duration, and the difference between the slot duration and the packet duration defines a gap duration within the ranging slot.

Clause 23. The device of clause 22, further comprising means for receiving a ranging response message (RRM) from the second device within the gap duration of the ranging slot at a reception time that is after the start time of the slot duration plus the packet duration.

Clause 24. The device of clause 23, further comprising means for receiving the RRM in the gap duration of the first ranging slot.

Clause 25. The device of clauses 21, 22, 23, or 24, wherein the means for retransmitting the RIM is based on a confidence metric that includes either a packet-specific confidence (PSC) metric value or a channel-specific confidence (CSC) metric value.

Clause 26. The device of clause 25, wherein the PSC metric value corresponds to interference on at least the first ranging slot as measured by the second device.

Clause 27. The device of clause 26, wherein the confidence metric indicates a failure to receive the RIM at the second device, or a low signal-to-interference and noise ratio (SINR) below a SINR threshold, or a figure-of-merit of the RIM received at the second device.

Clause 28. The device of clause 26, wherein means for retransmitting the RIM on the different ranging slot is based on the PSC metric value being below a predefined threshold value.

Clause 29. The device of clause 26, wherein the CSC metric value corresponds to frequency-specific behavior over channels utilized for transmission of the RIM, and the CSC metric value is based on the PSC metric value for different ranging slots.

Clause 30. The device of clauses 21, 22, 23, 24, 25, 26, 27, 28, 28, or 29, wherein the channel hopping pattern is a deterministic hopping pattern based on a predefined bitmap, or a random hopping pattern.

Clause 31. A non-transitory processor-readable storage medium comprising processor-readable instructions configured to cause one or more processors of a device to avoiding interference comprising: code for transmitting a ranging control message (RCM) to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; code for transmitting a ranging initiation message (RIM) on a first ranging slot; and code for retransmitting the RIM on a second ranging slot, different from the first ranging slot, based on the channel hopping pattern.

Clause 31. The non-transitory processor-readable storage medium of clause 30, wherein each ranging slot has a slot duration, the RIM includes a data packet that has a packet duration that is shorter than the slot duration, code for transmitting the RIM at a first transmission time that is approximately equal to a start time of the slot duration, and the difference between the slot duration and the packet duration defines a gap duration within the ranging slot.

Clause 32. The non-transitory processor-readable storage medium of clause 31, further comprising code for receiving a ranging response message (RRM) from the second device within the gap duration of the ranging slot at a reception time that is after the start time of the slot duration plus the packet duration.

Clause 33. The non-transitory processor-readable storage medium of clause 32, further comprising code for receiving the RRM in the gap duration of the first ranging slot.

Clause 35. The non-transitory processor-readable storage medium of clauses 31, 32, 33, or 34, wherein the code for retransmitting the RIM is based on a confidence metric that includes either a packet-specific confidence (PSC) metric value or a channel-specific confidence (CSC) metric value.

Clause 36 The non-transitory processor-readable storage medium of clause 35, wherein the PSC metric value corresponds to interference on at least the first ranging slot as measured by the second device.

Clause 37. The non-transitory processor-readable storage medium of clause 36, wherein the confidence metric indicates a failure to receive the RIM at the second device, or a low signal-to-interference and noise ratio (SINR) below a SINR threshold, or a figure-of-merit of the RIM received at the second device.

Clause 38. The non-transitory processor-readable storage medium of clause 36, wherein code for retransmitting the RIM on the different ranging slot is based on the PSC metric value being below a predefined threshold value.

Clause 39. The non-transitory processor-readable storage medium of clause 36, wherein the CSC metric value corresponds to frequency-specific behavior over channels utilized for transmission of the RIM, and the CSC metric value is based on the PSC metric value for different ranging slots.

Clause 40. The non-transitory processor-readable storage medium of clauses 31, 32, 33, 34, 35, 36, 37, 38, 38, or 39, wherein the channel hopping pattern is a deterministic hopping pattern based on a predefined bitmap, or a random hopping pattern.

Clause 41. A method for avoiding interference with an Ultra-wideband (UWB) device, the method comprising: receiving a ranging control message (RCM) to schedule a ranging session from a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots; receiving a ranging initiation message (RIM) on a first ranging slot; transmitting a confidence metric to the second device based on the received RIM; and receiving a retransmission of the RIM on a second ranging slot, different from the first ranging slot, based on the channel hopping pattern based on the confidence metric.

Clause 42. The method of clause 41, wherein the confidence metric is a packet-specific confidence (PSC) metric value that corresponds to interference on at least the first ranging slot as measured by the device.

Clause 42. The method of clause 42, wherein the confidence metric indicates a failure to receive the RIM at the device, or a low signal-to-interference and noise ratio (SINR) below a SINR threshold, or a figure-of-merit of the RIM received at the device.

Clause 43. The method of clause 42, wherein receiving the retransmission of the RIM on the different ranging slot based on the PSC metric value being below a predefined threshold value.

Clause 44. The method of clause 42, wherein the CSC metric value corresponds to frequency-specific behavior over channels utilized for transmission of the RIM, and the CSC metric value is based on the PSC metric value for different ranging slots.

Clause 45. The method of clause 41, wherein the channel hopping pattern is a deterministic hopping pattern based on a predefined bitmap, or a random hopping pattern.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed:

1. A device comprising:
at least one transceiver;
at least one memory; and
at least one processor, in signal communication with the at least one transceiver, and the at least one memory, the at least one processor configured to:
transmit, with the at least one transceiver, a ranging control message (RCM) to schedule a ranging session with a second device, wherein
the ranging session includes a plurality of consecutive ranging blocks,
each ranging block includes a plurality of ranging rounds,
each ranging round includes a plurality of ranging slots, and
the schedule includes a channel hopping pattern for the plurality of ranging slots;
transmit a ranging initiation message (RIM) on a first ranging slot; and
retransmit the RIM on a second ranging slot, different from the first ranging slot, based on the channel hopping pattern.

2. The device of claim 1, wherein
each ranging slot has a slot duration,
the RIM includes a data packet that has a packet duration that is shorter than the slot duration,
the at least one processor is configured to transmit the RIM at a first transmission time that is approximately equal to a start time of the slot duration, and
the difference between the slot duration and the packet duration defines a gap duration within the ranging slot.

3. The device of claim 2, wherein the at least one processor is further configured to receive a ranging response message (RRM) from the second device within the gap duration of the ranging slot at a reception time that is after the start time of the slot duration plus the packet duration.

4. The device of claim 3, wherein the at least one processor is further configured to receive the RRM in the gap duration of the first ranging slot.

5. The device of claim 1, wherein the at least one processor is configured to retransmit the RIM based on a confidence metric that includes either a packet-specific confidence (PSC) metric value or a channel-specific confidence (CSC) metric value.

6. The device of claim 5, wherein the PSC metric value corresponds to interference on at least the first ranging slot as measured by the second device.

7. The device of claim 6, wherein the confidence metric indicates a failure to receive the RIM at the second device, or a low signal-to-interference and noise ratio (SINR) below a SINR threshold, or a figure-of-merit of the RIM received at the second device.

8. The device of claim 6, wherein the at least one processor is configured to retransmit the RIM on the different ranging slot based on the PSC metric value being below a predefined threshold value.

9. The device of claim 6, wherein
the CSC metric value corresponds to frequency-specific behavior over channels utilized for transmission of the RIM, and
the CSC metric value is based on the PSC metric value for different ranging slots.

10. The device of claim 1, wherein the channel hopping pattern is a deterministic hopping pattern based on a predefined bitmap, or a random hopping pattern.

11. A method for avoiding interference with a device, the method comprising:
transmitting, with an at least one transceiver, a ranging control message (RCM) to schedule a ranging session with a second device, wherein
the ranging session includes a plurality of consecutive ranging blocks,
each ranging block includes a plurality of ranging rounds,
each ranging round includes a plurality of ranging slots, and
the schedule includes a channel hopping pattern for the plurality of ranging slots;
transmitting a ranging initiation message (RIM) on a first ranging slot; and
retransmitting the RIM on a second ranging slot, different from the first ranging slot, based on the channel hopping pattern.

12. The method of claim 11, wherein
each ranging slot has a slot duration,
the RIM includes a data packet that has a packet duration that is shorter than the slot duration,
transmitting the RIM at a first transmission time that is approximately equal to a start time of the slot duration, and
the difference between the slot duration and the packet duration defines a gap duration within the ranging slot.

13. The method of claim 12, further comprising receiving a ranging response message (RRM) from the second device within the gap duration of the ranging slot at a reception time that is after the start time of the slot duration plus the packet duration.

14. The method of claim 11, wherein retransmitting the RIM is based on a confidence metric that includes either a packet-specific confidence (PSC) metric value or a channel-specific confidence (CSC) metric value.

15. The method of claim 14, wherein the PSC metric value corresponds to interference on at least the first ranging slot as measured by the second device.

16. The method of claim 15, wherein the confidence metric indicates a failure to receive the RIM at the second device, or a low signal-to-interference and noise ratio (SINR) below a SINR threshold, or a figure-of-merit of the RIM received at the second device.

17. The method of claim 15, wherein retransmitting the RIM on the different ranging slot is based on the PSC metric value being below a predefined threshold value.

18. The method of claim 15, wherein
The CSC metric value corresponds to frequency-specific behavior over channels utilized for transmission of the RIM, and
the CSC metric value is based on the PSC metric value for different ranging slots.

19. The method of claim 11, wherein the channel hopping pattern is a deterministic hopping pattern based on a predefined bitmap, or a random hopping pattern.

20. A device for avoiding interference, the device comprising:
means for transmitting a ranging control message (RCM) to schedule a ranging session with a second device, wherein the ranging session includes a plurality of consecutive ranging blocks, each ranging block includes a plurality of ranging rounds, each ranging round includes a plurality of ranging slots, and the schedule includes a channel hopping pattern for the plurality of ranging slots;
means for transmitting a ranging initiation message (RIM) on a first ranging slot; and
means for retransmitting the RIM on a second ranging slot, different from the first ranging slot, based on the channel hopping pattern.
